(19) United States
(12) Patent Application Publication
(10) Pub. No.: US 2007/0238660 A1
(43) Pub. Date: Oct. 11, 2007

(54) Light activated antiviral materials and devices and methods for decontaminating virus infected environments

(76) Inventors: Stephen Michielsen, Cary, NC (US); Gordon Churchward, Atlanta, GA (US); Jadranka Bozia, Tucker, GA (US); Igor Stojilokivic, Decatur, GA (US); Suzana Anic, Decatur, GA (US)

Correspondence Address: JENKINS, WILSON, TAYLOR & HUNT, P. A., SUITE 1200, UNIVERSITY TOWER, 3100 TOWER BOULEVARD, DURHAM, NC, 27707, US

(21) Appl. No.: 11/598,549

(22) Filed: Nov. 13, 2006

Related U.S. Application Data
(60) Provisional application No. 60/788,010, filed on Mar. 31, 2006.

(51) Int. Cl. A01N 43/42; A01N 43/00; A01N 43/84; A01N 61/00; A01N 55/02; A01N 43/16

(52) U.S. Cl. 514/12; 514/1; 514/183; 514/185; 514/224.8; 514/297; 514/454; 514/680

(57) ABSTRACT

A method of inactivating viruses, articles for inactivating viruses and methods of manufacture of such articles are disclosed. Singlet oxygen generating dyes are attached to a substrate. Upon exposure to light, singlet oxygen is generated to inactivate viruses present. In a preferred embodiment, more than one dye is used. If only one dye is used, acridine yellow G is particularly effective.

### CROSS REFERENCE TO RELATED APPLICATION

This application is related to and claims priority to U.S. Provisional Application Ser. No. 60/788,010, filed Mar. 31, 2006 and entitled Light Activated Antiviral Materials and Devices and Methods for Decontaminating Virus Infected Environments. The disclosure of said provisional application is specifically incorporated by reference in its entirety herein.

### BACKGROUND OF THE INVENTION

1. Field of the Invention

This invention relates to the field of light-activated antiviral materials, systems and devices, methods for manufacture thereof and the use of such materials and devices to decontaminate viral infected environments and prevent viral infections. More specifically, the invention relates to the attachment of singlet oxygen generating materials and compounds to surfaces such as fabrics, particles, solid surfaces and the like to provide an antiviral environment through generation of singlet oxygen by illumination of such surfaces to generate singlet oxygen which functions to inactivate viruses, and to a certain extent, bacteria.

2. Discussion of the Relevant Art

Dyes such as the porphyrins, the fluoresceines, the phenothiaziniums, and the phthalocyanines, as well as others listed in Wilkinson, Helman et al. 1995, which is incorporated by reference herein in its entirety, and others not listed by Wilkinson, Helman et al are known as materials that release singlet oxygen upon exposure to light. In particular, phthalocyanine, aluminum phthalocyanine, protoporphyrin IX and zinc-protoporphyrin IX, which are well known materials, generate singlet oxygen when dispersed in free form and are known to be effective as antimicrobial agents.

In the past, it was thought that grafting of light-activated antimicrobial material, such as protoporphyrin and zinc-protoporphyrin to surfaces such as nylon films and fibers, would serve to preserve the films and fibers and prevent the transmission of disease through prevention of the transmission of bacterial infectious agents. One such approach is described in an article entitled “Grafting of Light-Activated Antimicrobial Materials to Nylon Films” by Jennifer Sherrilll, Stephen Michielsen, and Igor Stojiljkovic, published on Nov. 20, 2002, in Journal of Polymer Science, Part A Polymer Chemistry, Vol. 41, pages 41-47, 2003, the disclosure of which is specifically incorporated in its entirety by reference herein. That article describes various methods for respectively: 1) synthesis of various derivatives of protoporphyrin; and 2) grafting such derivatives such as PPIX-ED or Zn-PPIX-ED to PAA-grafted nylon films.

In a later article entitled “Porphyrin-Based, Light-Activated Antimicrobial Materials” by Jadranka Bozja, Jennifer Sherrill, Stephen Michielsen, and Igor Stojiljkovic, published on Jun. 11, 2003 in Journal of Polymer Science, Part A Polymer Chemistry, Vol. 41, pages 2297-2303, 2003, the disclosure of which is also incorporated in its entirety by reference herein, the antimicrobial properties of the aforementioned protoporphyrin grafted nylon fibers as tested were described. The fibers were shown to be somewhat active against Staphylococcus aureus and Escherichia coli, depending upon light intensity to which the fibers were exposed as well as exposure time.

While some effectiveness against such bacteria was shown, later tests have shown that the antibacterial effect of such grafted or bound protoporphyrin materials may not be sufficiently effective against bacteria to be of effective use when attempted in the manner discussed in the article. Further tests have shown that when the protoporphyrin materials are bound to fabrics as disclosed therein, that there may be an insufficient amount of singlet oxygen generated due to lack of effective exposure of the dyes to light to be fully effective against such bacteria. Thus, although it is known that protoporphyrin and other like dyes can be effective in a free form when exposed to light, and in that form generate sufficient singlet oxygen to be effective against selected bacteria, in contrast, when the dye is bound to fabrics, broad effectiveness against bacteria declines substantially.

It is desirable to develop methods and systems to address the spread of influenza. Influenza is only one of many viruses that are spread by aerosolized droplets when infected people cough or sneeze. It spreads rapidly throughout the world in seasonal epidemics. The World Health Organization estimates that influenza epidemics cost the US economy $ 71-167 billion per year. It is also estimated that 250,000-500,000 people die every year from influenza epidemics. Current fears of a pandemic due to the avian H5N1 strain of influenza (the “bird flu”) illustrate that we have still not found a viable way of preventing pandemics. Although vaccination has been shown to be effective in reducing the occurrence and severity of influenza infections, because of rapid variation in the antigenic properties of circulating viruses, new vaccines have to be produced on annually. Time constraints and reliance on growth of vaccine stocks in eggs means that only limited supplies of vaccine are available in any single flu season. There are only two classes of pharmaceuticals that are effective against influenza which inhibit virus uncoating and virus release, and recent studies indicate that these drugs are losing their effectiveness as the virus develops resistance. The development of new drugs to fight viral infections has proven to be extremely difficult. In addition, the cost of the current methods for preventing or treating viral infections is prohibitive in many regions of the world, including those regions where many of these infections are believed to originate. Therefore, a new, low cost approach to preventing the spread of viral infections in general, and influenza in particular, would be extremely beneficial.

One system used against viruses involves photodynamic therapy. Photodynamic therapy in general has been shown in the past to be able to inactivate many enveloped viruses, including HIV through the production of singlet oxygen, Δ_{g}. The mechanism of inactivation of enveloped viruses with the use of Rose Bengal or hypericin has been investigated and it was found that singlet oxygen crosslinked protein G on the surface of VSV, thus inhibiting viral fusion. A similar mechanism inactivates other like viruses. Virus inactivation is proportional to the intensity of light used. Both materials are known to produce singlet oxygen on exposure to light and both were ineffective in the dark. It was shown that singlet oxygen produced thermally from the decomposition of poly(1,4-dimethyl-t-vinylnaphthalene-1,4-endoperoxide) also inactivated enveloped viruses, confirming that singlet oxygen was the active material. However, to date it has not been known how to effectively apply photodynamic therapy in useful methods, articles and systems.

To understand the principle of operation of the dyes described herein, it is noted that the ground state of normal oxygen has its two most energetic electrons arranged with parallel spin in a π molecular orbit to produce a state that is described as a spin triplet state represented by the spectroscopic notation Σ. Situated 95 kJ above this state is a state where the electrons in the Δ_{g} molecular orbital have opposite spin yielding a spin singlet state Δ_{g}. It is this excited state that is commonly referred to as singlet oxygen. One effective way of generating singlet oxygen is the use of metal substituted porphyrin, phthalocyanine and other molecules as described above and hereafter which have been integrated as reactive, visible light activated photocatalysts within chemical/biological agent resistant flexible polymer barrier coatings which have been previously developed. Such photocatalysts are large ring compounds that have strong absorption in the visible region of the spectrum and can be blended to match required color specifications.

### BRIEF SUMMARY OF THE INVENTION

In one aspect the invention relates to a method of inhibiting growth of viruses by inactivation. An effective amount of a composition of a dye is attached onto a substrate. The dyes are reactive dyes and dyes containing reactive functional groups. The dyes are further characterized by having the ability to absorb light in a predetermined spectrum and intensity range to produce singlet oxygen in the presence of an oxygen containing atmosphere in an amount effective to inactivate viruses.

In a preferred aspect, the dyes are at least two different dyes, and more preferably three, each selected to be effective in generating singlet oxygen when exposed to light of a different spectrum range from the other dyes.

In a yet more specific aspect the dye is of the following basic structure: 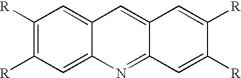
Where R is a hydrogen, a hydroxyl, a carboxylic acid, an alkyl, an amino or a substituted amino group or other group obvious to one skilled in the art. At least one of the R's being an amino, hydroxyl, carboxylic acid, or other reactive group.

More specifically, the dye is one of acridine yellow G, proflavin and acroflavin. Most preferably, the dye is acridine yellow G.

In another aspect, the invention relates to an article of manufacture for inhibiting growth of viruses. A substrate has an effective amount of the aforementioned dye adhered thereto which upon absorption of light generates singlet oxygen as previously described.

Yet still further, the invention also relates to a method of manufacturing such articles.

In a yet still more specific aspect the substrate can be fibers and fabrics, as well as other types of surfaces.

For purpose of this disclosure, it is noted that term “attached” is meant molecular bonding, coating, impregnation, adsorption and other forms of attachment as will be apparent to those of ordinary skill. In addition, by substrate is meant at least one fiber, a fabric, or other types of surfaces such as walls, wall coverings, paper, paint, plastic, non-woven fabrics, etc., and generally any surface to which dyes described herein can be attached as will be readily apparent to those of ordinary skill.

In one aspect, in accordance with the invention, it has been discovered that a method of binding protoporphyrin and other singlet oxygen generating materials to fabrics can be effectively practiced in a manner in which sufficient singlet oxygen can be generated such as to be effective in certain unexpected and untried applications. More specifically, while proporphyrin and singlet oxygen generation in bound form was in the past considered to be somewhat effective against selected types of bacteria, it has unexpectedly been discovered that such materials when modified in accordance with the invention described herein, can be bound to materials such as fabrics, generate sufficient singlet oxygen to be effective against viruses. It has been discovered that materials prepared in accordance with the invention described herein can have the effect of neutralizing viruses of the type that are “enveloped”, such as influenza, vaccinia, and the like.

While the effectiveness of porphyrin and singlet oxygen has been demonstrated against bacteria when the porphyrin is in free form, in bound form it is less effective against bacteria. Since the mechanism by which the bacteria are killed by singlet oxygen is substantially different from what occurs in an environment containing viruses, and the operation on viruses due to their substantially different nature than bacteria, the effectiveness of singlet oxygen generating dyes against viruses as described herein is completely different, unexpected and unanticipated.

### BRIEF DESCRIPTION OF THE SEVERAL VIEWS OF THE DRAWINGS

FIG. 1 is a graph showing the spectrum and relative intensity of light reflected off of fabric containing certain dyes on a fabric in accordance with the invention.

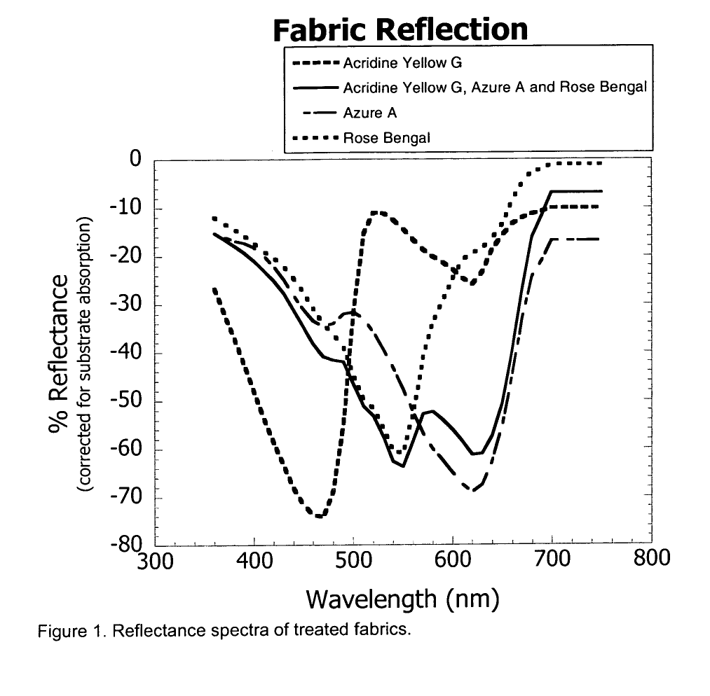

FIG. 2 is a graph illustrating virus inactivation by a nylon fabric having poly(acrylic acid) attached thereon, and a fabric from example 7.

FIG. 3 is a graph illustrating virus inactivation by a fabric having azure A or Rose Bengal dyes attached thereon; and

FIG. 4 is a graph illustrating virus inactivation by a fabric having acridine yellow G attached thereon.

### DETAILED DISCUSSION OF THE INVENTION

The development of the invention is based in part on recent events that have led to new concerns about biowarfare and bioterrorism. Because of the potential range of biological agents that could be used, a non-specific decontamination system is desirable. Of particular interest herein are materials whose surfaces have been modified to be self-decontaminating and self-regenerating. Other beneficial requirements are that the surface treatment be very light weight. These coatings are based on Light Activated Antiviral Materials, i.e., LAAM that have been developed. The LAAM coatings have the further attribute that they are able to be color matched to nearly any color desired.

The invention addresses in part surface modification. In one embodiment of a coating developed as part of the invention an about 10 to about 20 nm, and typically about 5-15 nm, and most typically about 10 nm thick mediator or amplifying polymer is bonded to the surface of fibers. Then photo-active agents are grafted to this mediator polymer. By the term mediator or amplifying polymer is meant a polymer that attaches or binds to reactive sites on the surface and creates many more reactive sites for attachment. It is, in effect, a surface site amplifying material. This increases the available photo-active agents by greater than 100 fold, while adding less than 0.5 wt % and typically less than 0.1 wt % to the substrate. The amount is net by weight of active reagent versus the weight of the substrate. These photo-active agents absorb visible light and transfer the energy to oxygen in the air to generate singlet oxygen, which has been shown to destroy certain microbes. Since the photo-active agents are organic dyes, it is possible to simultaneously match specification colors.

As already noted, there has long been an interest in the development of self-decontaminating treatments for hard and soft surfaces that do not contribute significantly to weight nor require transport or handling of decontamination supplies, as well as which have zero toxic effluents. As described herein, a self-decontaminating surface based on the synthesis of singlet oxygen from photo-active organic dyes has been developed.

Any treatment designed with the aim of decontamination must be effective against as wide a variety of agents as possible, and not targeted against specific features of an individual organism. Decontamination of microbes is typically carried out by irradiation, exposure to solvents or exposure to agents that cause oxidative damage to biological macromolecules. These latter treatments include bleach and gases such as ethylene oxide and chlorine dioxide. In the environments where human beings are present, use of irradiation either with gamma rays or high intensity UV irradiation is undesirable, as is the exposure of personnel to organic solvents and noxious gases. However, the Light Activated Antiviral Materials, LAAM, technology discussed in a subsequent paragraph results in the in situ production of singlet oxygen, which is one of a number of reactive oxygen species that cause oxidative damage to lipids and proteins. In proteins, target amino acids are Trp, His, Tyr, Cys and Met. This technology has also been shown to be somewhat effective against gram positive bacteria. This suggested the incorporation of LAAM technology into the design of materials will confer the substantial benefit of decontamination of a broad range of biological agents. However, further testing has shown that when such LAAM materials are bonded, as developed with the invention, such materials have been shown to be of limited effect against Gram positive bacteria. However, as further modified herein, such dyes bonded to surfaces such as fabrics have been shown to be highly effective against enveloped viruses.

In accordance with the invention, there have been developed light activated antiviral materials, LAAM. These materials absorb visible light to convert oxygen from the air or dissolved in water to Δ_{g} oxygen. LAAMs have been developed for treating individual fibers, yarns, fabrics, particles, or other surfaces. In one embodiment, protoporphyrin IX, (PPIX), and zinc protoporphyrin IX, (Zn-PPIX), have been chemically bonded for example, as discussed in the aforementioned article entitled “Grafting of Light-Activated Antimicrobial Materials to a Nylon Film” to the surface of nylon films and fabric using poly(acrylic acid), PAA, as a mediator polymer. PAA is first dissolved in water and grafted onto the nylon surface in the presence of coupling agents. The PAA could not be removed in multiple washings. Next, an amide bond was formed between the carboxylic acid groups in PPIX and the amino groups in ethylene diamine. Finally, these derivatives were grafted to PAA, again by forming amide bonds, this time between the other end of the ethylene diamine and the acid groups in PAA. In this way, it is possible to graft multiple molecules to a single PAA molecule, which is attached to the nylon surface. Without the PAA acting as a mediator or amplifier to bond PPIX, only one PPIX molecule could be attached per surface nylon molecule. In other words, the PAA mediator increased the amount of PPIX or Zn-PPIX on the surface. Fabrics made using this treatment were able to destroy to a certain extent Gram positive bacteria and more effectively enveloped viruses. The essential features of this approach are that the LAAM are composed of suitable dyes that absorb UV/visible/near infrared light. The excited state of the dye exchanges its spin and energy with oxygen from the air to produce Δ_{g} oxygen. The LAAM dye must resist photobleaching and photo-oxidation for the intended duration of use. A high quantum yield is desirable. The LAAM dye is preferable such that it is able to be grafted to a suitable mediator polymer or capable of conversion to a form which can be grafted to a suitable mediator polymer. Finally, the modified surface should have the desired colors, for example, for military or other applications. Fortunately, there are a large number of dyes to select from, so that finding a suitable LAAM dye is not difficult. Furthermore, LAAMs covering the entire range of colors desired are readily achieved.

In one preferred aspect, at least two and preferably three dyes are employed. The dyes are selected to cover the spectrum from near infrared to UV light to thereby be effective against viruses in all light conditions. If only one dye is used, dyes having the previously claimed basic structure are employed because of the high and unexpected level of effectiveness against viruses which was not found with other dyes. In a most preferred aspect the single dye is acridine yellow G. Of course, the dyes having said formula, including acridine yellow G can also be combined with other dyes to cover the full spectrum described.

Since most typically in excess of about 75% by weight and more typically in excess of 90%, of all of the photo-active material is on the surface, these LAAMs add very little weight to the finished products. They are self-regenerating because they use oxygen from the air and light, either natural or artificial, to replenish their decontamination material. In addition, there are no effluents since the active ingredient, Δ_{g} oxygen, has a lifetime of less than about 10 msec before it reverts back to ground state oxygen, which is present in air everywhere. In addition, it is not corrosive nor does it produce salts. Thus, LAAMs provide a highly desirable decontamination means.

One first step in making a LAAM fabric surface is to attach LAAM material to the surface. This is accomplished by grafting suitable photo-active materials to the surface, i.e. to form a LAAM on the surface. Reactive porphyrin and phthalocyanine dyes are examples of dyes which can be chemically grafted upon the surfaces and have high quantum yields for producing Δ_{g} oxygen. Specifically, fabrics of polyaramid, polyamide or polyesters such as poly(ethylene terephthalate) fibers are used as surfaces. Onto these fibers, there is adsorbed and grafted poly (acrylic acid), PAA, to form PAA-g-fabric. Next, protoporphyrin IX, zinc protoporthyrin IX, phthalocyanine or other dyes are grafted to the PAA-g-fabric as described by the aforementioned article entitled “Grafting of Light-Activated Antimicrobial Materials to a Nylon Film.”

The resulting LAAM fabric was tested for its ability to (1) produce Δ_{g} oxygen, and (2) to render various viruses harmless. Each of these tests is described in more detail hereinafter. Because of the hundreds of dyes that are known to efficiently produce Δ_{g} oxygen, there is no undue difficulty in accomplishing this task.

Dyes with high quantum yields for producing singlet oxygen may be selected from reference literature. Dyes known to have a high singlet oxygen quantum yield include the porphyrins, the fluoresceines, the phenothiazines, the xanthenes and the phthalocyanines. These dyes cover nearly all of the visible spectrum as well as the near infrared and the near ultraviolet. The dyes are selected based on the ease with which they can be grafted to poly(acrylic acid), poly(ethylene imine) or other mediator polymer. In particular, dyes are selected containing alkene, carboxylic acid, hydroxyl, amino, thiol and other reactive groups.

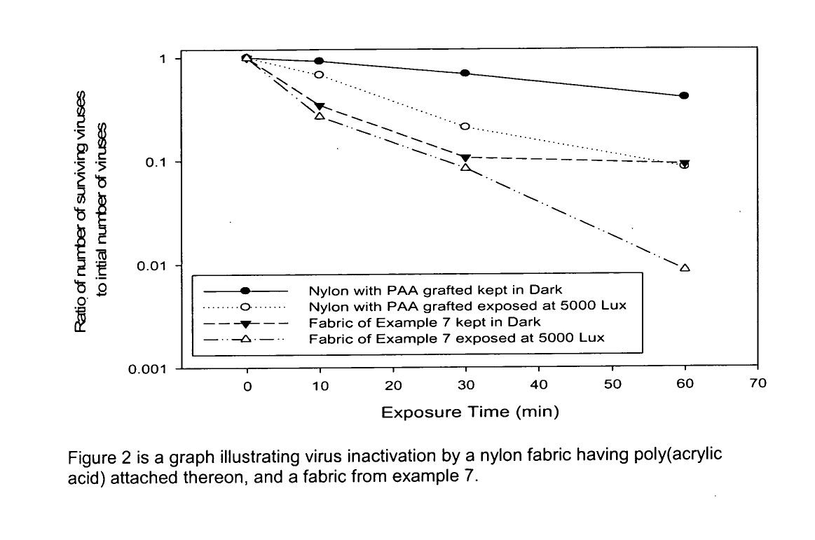

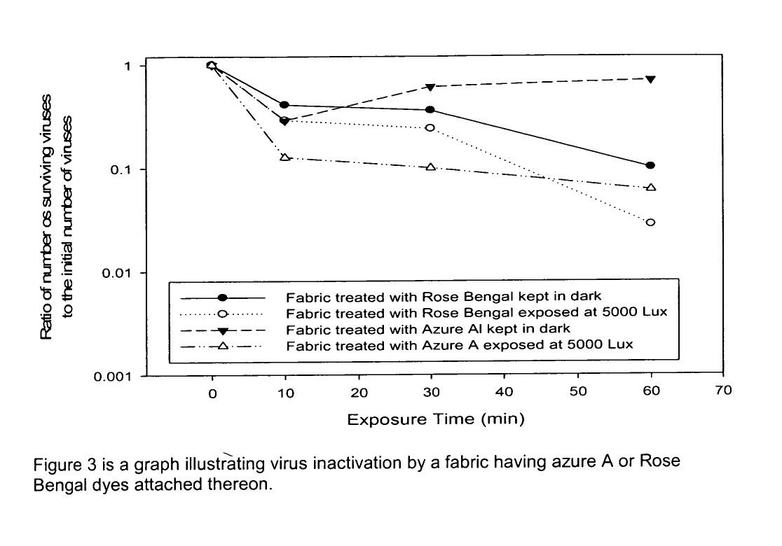

FIGS. 2, 3 and 4 show effectiveness of specific dyes against virus. Acridine yellow G shows unexpected and very high virus inactivation with low light illumination levels.

The following is a representative listing of the dyes, but the listing is not limited to these dyes as will be readily apparent to those of ordinary skill.

Suitable dyes are those that generate singlet oxygen upon exposure to light and that contain chemical moieties that allow them to be chemically bonded to the surface or to the mediator polymer. These include many of the dyes listed by Wilkinson, Helman and Ross (J. Physical Chem. Ref. Data, Vol 24, pp 663-1021) including protoporphyrin IX, zinc protoporphyin IX, Rose Bengal, thionin, Azure A, Azure B, Azure C, proflavine, acriflavine, vinyl anthracene, 1-amino-9,10-anthraquinone, 1,5-diamino-anthraquinone, 1,8-diamino-anthraquinone, 1,8-dihydroxy-9,10-anthraquinone, 1-hydroxy-9,10-anthraquinone, 1,4,5,8-tetraamino-9,10-anthraquinone, 1,4,5,8-tetrahydroxy-9,10-anthraquinone, Eosin B, Eosin Y, Phloxin B, fluorescein, Erythrosin, tribromo-fluorescein, hypericin, kynurenic acid, riboflavine, chlorophyll a, chlorophyll b, coproporphyrin I, coproporphyrin II, coproporphyrin III, Ga protoporphyrin IX, clorin e6, proflavin, acroflavin, acridine yellow G, toluidine blue, anthracine derivatives, anthraquinones, tetracarboxyphthalocyanine, Sn tetracarboxyphthalocyanine, Al tetracarboxyphthalocyanine, Ge tetracarboxyphthalocyanine, 5-amino-etioporphyrin I, chlorin e6, as well as the zinc and aluminum derivatives of the above listed porphyrin and phthlocyanine derivatives, or other dyes that will be obvious to those skilled in the art. In addition, many other dyes that generate singlet oxygen upon illumination can be used provided that they can be attached to the surface or to a mediator polymer.

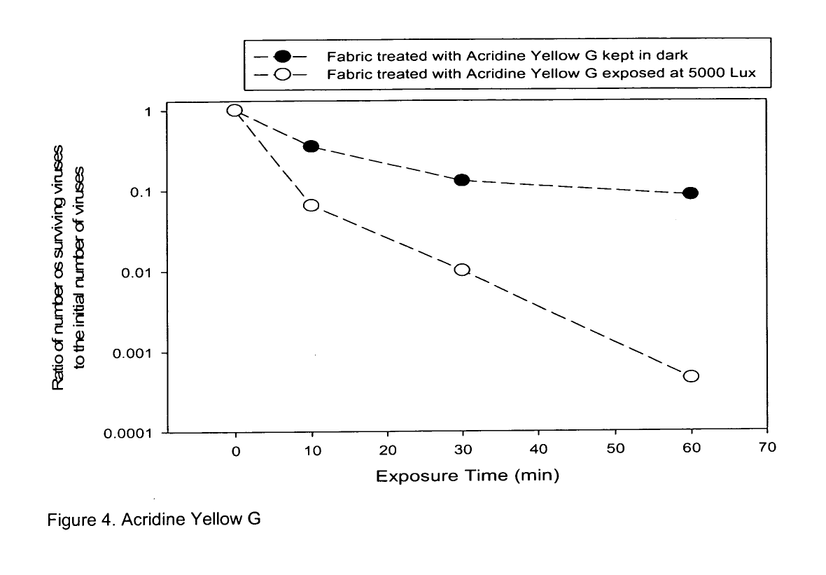

In addition to the above dyes, as shown in FIG. 4, acridine yellow G has shown unexpected efficiency in virus inactivation.

The LAAM materials developed were tested for their ability to retain their antiviral activity. The biological tests are described hereinafter.

When the LAAM was a fabric, a chemical trapping method was used to measure the amount of singlet oxygen generated under different illumination conditions. Furfuryl alcohol is known to react rapidly with singlet oxygen. An aqueous solution of furfuryl alcohol is added to a sealed circulation system containing the fabric sample and oxygen saturated water. The dissolved oxygen concentrations were measured during illumination. The dissolved oxygen concentration decreased as singlet oxygen was photochemically generated and reacted with furfuryl alcohol.

Choice of agents and biological testing:

Testing initially focused on bacteria and poxviruses. Bacillus subtilis served as a model for decontamination of Gram positive bacteria. As a model for poxviruses, we used vaccinia virus. The vaccinia virus can be safely handled in a normal micobiological laboratory and does not require any special containment facilities.

In accordance with the invention, it is effective against Yersinia pestis, yellow fever (for the flavivirus encephalitis viruses), sindbis virus (alpha virus encephalitis virus), avian infectious virus (corona diseases such as SARS) and parainfluenza virus (the highly pathogenic nipah and hendra viruses.)

Having described the invention generally, the following are specific examples showing manufacturing and use of specific embodiments of the invention for inactivating viruses.

### EXAMPLE 1

Virucidal activity of Zn-protoporphyrin IX (Zn-PPIX) grafted onto nylon (pieces of cloth, size 1 by 1 cm) was tested against infectious vaccinia viruses. The Zn-PPIX grafted nylon fabric was made as follows. Poly(acrylic acid) (PAA) was dissolved in water at a concentration of 1.4 g/L. A piece of nylon fabric was immersed in 35 ml of this solution. 10 ml of an aqueous solution of 4-(4,6-dimethoxy-1,3,5-triazin-2-yl)-4-methylmorpholinium chloride (DMTMM) was added (20 g/L). The solution was gently shaken for 1 hour, the fabric was removed from solution, rinsed with water and dried. The fabric formed had PAA grafted onto its surface. Next, 0.1 g of Zn-PPIX, 0.2 g of DMTMM, and 100 μL of ethylene diamine were dissolved in 120 mL of water and stirred for 30 minutes. At this point, the PAA-grafted nylon fabric was placed in this reaction mixture. Excess solution was squeezed out and the fabric dried and cured at 120° C. for 40 minutes. The resulting Zn-PPIX nylon fabric was obtained by evaporating the water to dryness. This fabric was then cut into 1 cm by 1 cm pieces for antiviral activity testing.

For the assay of the effect on vaccinia virus infection, a plaque assay was used. This assay is able to determine how many infectious particles remain after LAAM light treatment.

BSC40 cells were used. The following samples were tested: 1) 20 μl of virus stock (conc. 1×10⁶) was added to Zn-PPIX treated fabric, 2) 20 μl of virus alone, 3) 20 μl of wash media, samples were illuminated for 30 min. at 60,000 Lux., 4) 20 μl of virus stock on Zn-PPIX treated fabric was kept in the Petri dish wrapped in Al foil as a control. After 30 minutes, cells were infected. Two days after infection, medium was removed, cells were stained, and the number of plaques was counted. Results are as follows:
Virus on Zn-PPIX treated fabric (illuminated)—no plaques
Virus alone: in 10⁻² dilution 70 plaques
Virus on Zn-PPIX treated fabric (control, dark): in 10⁻² dilution—40 plaques
Wash media alone—no plaques

### EXAMPLE 2

With respect to bacteria with light exposure as described above (Light at 60,000 Lux and Zn-PPIX treated fabric), the grafted materials were somewhat effective on Bacillus strains.

Two Bacillus strains were used in experiments:

Bacillus cereus strain by BGSC code 6A5 (original code: ATCC14579), description; wild type isolate, type strain of B. cereus.

Bacillus thuringiniensis, BGSC No. 4A1; original code NRRL-B4039; description: wild type isolate.

We tested the extent to which Zn-PPIX treated fabric was able to inactivate Bacillus cereus and B. huringiensis spores to germinate and produce viable vegetative cells. 1 cm by 1 cm pieces of LAAMs (Nylon, PPIX, and Zn-PPIX) were immersed in fresh spore dilution (ABS₅₈₀0.3) and then exposed to light. The source of light was a tungsten lamp. Light intensity under 60,000 Lux did not have an effect on spores. At 60,000 Lux during the 30 minute exposure, only Zn-PPIX treated fabric had an effect on spores: 20.16% of spores of strain 4A1 was able to produce viable vegetative cells, and from strain 6A5-23.14%. Control cultures were left in the dark for the same amount of time (30 min.) and did not show any reduction in the number of the spores. PPIX and nylon had limited effect on spores at 60,000 Lux.

### EXAMPLE 3

Cerex Suprex HP spunbonded nylon nonwoven (DuPont) with a basis weight of 45 gsm. 2.0 g of poly(acrylic acid) of molecular weight 450,000 was dissolved in 500 ml of water. The nonwoven fabric was pulled through this solution and squeezed between padder rolls to a wet pickup of 135% wt/wt of fabric. The treated fabric was allowed to sit for two days covered with aluminum foil to prevent water evaporation, then rinsed with fresh water six times. Next, an aqueous solution of 4-(4,6-dimethoxy-1,3,5-triazin-2-yl)-4-methylmorpholin-4-ium chloride, DMTMM, consisting of 0.41 g DMTMM in 250 ml water was made up and the treated fabric pulled through this solution and squeezed to remove excess solution. This fabric was allowed to sit covered with aluminum foil for two hours and rinsed 6 times.

### EXAMPLE 4

A portion of the fabric made in Example 3 was treated with Acridine Yellow G as follows. 0.185 g of Acridine Yellow G and 0.364 g of DMTMM were dissolved in 250 ml of water. The fabric of example 3 was pulled through this solution and excess was squeezed out between padder rolls. The fabric was allowed to sit for 24 hours whereupon it had a vibrant yellow color. Unreacted dye was extracted by rinsing until no more color was observed in the rinse water.

### EXAMPLE 5

A portion of the fabric made in Example 3 was treated with Azure A as follows. 0.231 g of Azure A and 0.329 g of DMTMM were dissolved in 250 ml of water. The fabric of example 3 was pulled through this solution and excess was squeezed out between padder rolls. The fabric was allowed to sit for 24 hours whereupon it had a pale blue color. Unreacted dye was extracted by rinsing until no more color was observed in the rinse water.

### EXAMPLE 6

A portion of the fabric from Example 3 was treated with Rose Bengal as follows. First, Rose Bengal was derivatized to add an amino linkage group by dissolving 0.47 g Rose Bengal in 2 ml of ethylene diamine and 6 ml of water. This solution was refluxed for 30 minutes, and rotoevaporated to dryness to remove excess ethylene diamine. The product was a deep red, viscous liquid.

Then, 1.99 g of poly(acrylic acid) was dissolved in 500 ml water. The fabric of example 3 was pulled through this solution and squeezed between padder rolls to a wet pickup of 135% wt/wt of fabric. The treated fabric was allowed to sit for 30 minutes covered with aluminum foil to prevent water evaporation. 0.346 g DMTMM was dissolved in 250 ml of water and the fabric was pulled through this solution, excess solution squeezed out with a padder and allowed to sit covered for 30 minutes. One half of the Rose Bengal amine derivative was dissolved in 250 ml of water, the treated fabric pulled through this solution, excess solution squeezed out on a padder and the fabric allowed to sit for 30 minutes. Next, 0.16 g DMTMM was dissolved in water and padded onto the fabric as described previously. The fabric was allowed to sit for 30 minutes, then rinsed with water until no further color was seen in the rinse water. The treated fabric was pink.

### EXAMPLE 7

A portion of the fabric from Example 3 was treated with Rose Bengal, Acridine Yellow G, and Azure A dye mixture as follows. One half of the Rose Bengal amine derivative described in Example 5 along with 0.049 mg Azure A, and 0.051 mg Acridine Yellow G were dissolved in 250 ml of water.

Then, 1.99 g of poly(acrylic acid) was dissolved in 500 ml water. The fabric of example 3 was pulled through this solution and squeezed between padder rolls to a wet pickup of 135% wt/wt of fabric. The treated fabric was allowed to sit for 30 minutes covered with aluminum foil to prevent water evaporation. 0.346 g DMTMM was dissolved in 250 ml of water and the fabric was pulled through this solution, excess solution squeezed out with a padder and allowed to sit covered for 30 minutes. Next, 0.16 mg of DMTMM was added to the mixed dye solution made above and the poly(acrylic acid) treated fabric was pulled through the mixed dye solution, excess solution squeezed out on a padder and the fabric allowed to sit for 30 minutes, then rinsed with water until no further color was seen in the rinse water. This treated fabric had a lavender color. In later testing it was noted that the acridine yellow G did not attach.

### EXAMPLE 8

Zinc protoporphyrin IX was converted to an amine derivative by dissolving 50 mg of zinc protoporphyrin IX in 20 ml of dimethyl formamide. To this solution, 10 mg of ethylene diamine was added, followed by 9 mg of N-hydroxy-succinimide, NHS, and 46 mg of 1-ethyl-3-(3-dimethylaminopropyl) carbodiimide hydrochloride, EDC. The reaction was allowed to proceed for 24 hours. During this time, poly(acrylic acid) of 450,000 g/mol molecular weight was grafted to nylon-6,6 fabric in the form of a bridal veil as follows: a two inch strip of nylon bridal veil was cut. Then 250 mg of poly(acrylic acid) were dissolved in 200 mL of water. Next, 0.05 g of DMTMM was added to the solution and the bridal veil was pulled through the solution and excess solution squeezed out. The fabric was allowed to dry in air over night. The treated fabric was then rinsed with water three times and dried. Finally, the treated fabric was immersed in the zinc protoporphyrin IX solution prepared above after adding 0.05 g of DMTMM to the solution. The treated and soaked fabric was then squeezed to remove excess solution, covered and allowed to react for 24 hours. Finally, the fabric was washed extensively with water followed by methanol to remove any ungrafted material.

With respect to polymer fabrics to which the singlet oxygen generating dyes can be attached, the following discussion provides additional details.

In attaching dyes to polymers, it has been discovered that in general, the surfaces of many polymers have too few reactive groups to attach the singlet oxygen generating dyes. To overcome this difficulty, a surface site mediator or amplifying polymer that contains a large number of reactive sites can be attached. For example, nylon 6,6 contains only two reactive groups per molecule, an amino group and a carboxylic acid group. If the dyes are attached directly to the surface of nylon 6,6, there will be too few dye molecules to be effective. However, poly(acrylic acid) can be covalently bonded to the amino ends or poly(ethylene imine) can be attached to the carboxylic acid groups. Both of these polymers contain a reactive group in each repeat unit. Thus, using poly(acrylic acid) and covalently attaching it to the nylon 6,6 surface can increase the number of reactive sites several hundred to several thousand fold. A suitable choice of dyes can then be attached to the surface at much higher levels than without this surface site amplifying polymer.

In picking a polymer, it is important to note that in cellulosic polymers, the concentration of reactive groups on the surface is adequate so that the surface site mediator or amplifying polymer is not needed.

For each polymer the surface site mediator or amplifying polymer must be chosen to contain reactive groups that are capable of reacting with groups on the surface. Reactive sites commonly found on the surface of fibers include hydroxyl (—OH), carboxylic acid (—COOH), and amino (—NH₂ or —NH—) groups. Other groups may also be present or can be added to the surface by means known to those skilled in the art, such a plasma treatment, UV-activation, corona treatment, and etc.)

Suitable surface site mediator or amplifying polymers include poly(acrylic acid), poly(ethylene imine), poly(vinyl alcohol), poly(maleic anhydride), poly(ethylene-co-maleic anhydride), poly(vinyl phenol), and their copolymers with ethylene, propylene or other materials (known to those skilled in the art).

The dyes can be attached to these surface site amplifying polymers through covalent bonding of suitable groups on the dyes to the reactive functional groups in the surface site amplifying polymer. For example, a dye containing an amino group can be covalently bound to poly(acrylic acid) by forming an amide bond between the carboxylic acid groups of poly(acrylic acid) and the amino group(s) of the dye molecule. Azure A is an example of a dye that can be covalently linked to poly(acrylic acid) by reacting the —NH₂ group on Azure A with a —COOH group of the poly(acrylic acid) repeat unit. Other dye-surface site amplifying polymer combinations can also be used, as will be obvious to one skilled in the art.

If the dye contains a reactive group, but it cannot react directly with the surface site mediator or amplifying polymer or the polymer surface, a short linker molecule can first be covalently bonded, for example, to the dye followed by covalently bonding the modified dye to the surface site amplifying polymer or the polymer surface. The order of bonding can be reversed, such that the linker molecule can first be attached to the surface site amplifying polymer or the polymer surface followed by covalently linking it to the dye. The short linker molecule should have one or more groups that can be covalently linked to the dye and one or more groups that can be covalently linked to the polymer surface or the surface site amplifying polymer. These groups may be different or they may be the same. The choice of linker molecule reactive groups will be obvious to one skilled in the art. For example, to attach a dye that only has carboxylic acid reactive groups to a carboxylic acid based surface site amplifying polymer, a diamine, such as ethylene diamine, hexamethylene diamine, etc., can first be attached to the dye molecule followed by attachment to the surface site amplifying polymer.

In accordance with further aspects of the invention, singlet oxygen production is optimized under solar, tungsten lamp, fluorescent light illuminants and ambient light and/or light typically as low as 2500 Lux when multiple dyes are used. In such a case, at least two dyes may be used, and preferably three, each having a spectrum of absorption to generate singlet oxygen different from that of the others.

In the case of acridine yellow G, exposure to light as low as 500 Lux served to inactivate at least 99% of viruses exposed to singlet oxygen generated thereby. In one specific and effective application, acridine yellow G, or other dyes of the structure described herein, can be employed with two other dyes which generate singlet oxygen when each additional dye is exposed to light at a different spectrum from that of acridine yellow G and the other dye.

Candidate dyes are chosen as those that generate the most singlet oxygen per unit light intensity for specific light sources simulating solar, indoor and fluorescent lighting. The dyes or combinations are attached to a mediator polymer that permit them to be attached to the surface of filter media.

In one embodiment, the invention also involves methods for applying the photo-active dyes to the surface of air filtration media while maintaining singlet oxygen production efficiency, filtration efficiency, and low pressure drop across the filter.

Dye-carrier combinations are optimized as can be understood by one of ordinary skill to correct for any changes in the dyes' activity upon attachment to the carrier. The dye-carrier combinations are attached to the filter media surfaces. The conditions for attachment are optimized to: 1) maximize singlet oxygen generation; and 2) minimize changes in the air filtration performance.

The invention results in a real world environment application by resulting in a mask that inactivates influenza virus.

The inventors herein have developed a less expensive, more robust method of attaching materials to surfaces using 4-(4,6-dimethoxy-1,3,5-triazin-2-yl)-4-methylmorpholinium chloride, DMTMM, other types of amide bond formation or just with heat. Heat is a simple and low cost method of attaching the dyes. The cost of applying these materials has been reduced and the class of dyes has been expanded to include Rose Bengal, Azure A and related dyes. Many singlet oxygen producing dyes can now be attached to the surface of nylon or other materials as obvious to one skilled in the art using the techniques described herein as part of this invention.

When the dye contains a carboxylic acid group, it is grafted either to poly(ethylene imine) through the NH group on the imine or by first grafting it to a diamine such as ethylene diamine or 1,6-diaminohexane. When the dye contains a free amino group, it will be grafted directly to poly(acrylic acid). Two approaches are used to attach carboxylic acid groups to amino or imine groups. First, to ensure grafting, 4-(4,6-dimethoxy-1,3,5-triazin-2-yl)-4-methylmorpholinium chloride, DMTMM, is used.

As an alternative to polyacrylic acid, another approach, which is the preferred embodiment due to reduced chemical usage and reduced cost is to form the amide directly by heating the acid containing and amine containing groups to drive off water. This approach is used to produce billions of pounds of polyamides annually and is a commercially viable route. Recent efforts in the laboratory indicate that the dyes can be readily attached to poly(acrylic acid) using this approach and that poly(acrylic acid) or the dye-modified poly(acrylic acid) can be attached to nylon.

Specifically, Azure A is grafted to poly(acrylic acid) by dissolving both in a water solution and adding DMTMM. After stirring for 30 minutes, the unreacted Azure A is removed by dialysis using a Millipore Amicon Ultra 100,000 molecular weight cut-off filtration membrane and a centrifuge. This retains any Azure A that has grafted to 450 kD poly(acrylic acid) and pass any unreacted Azure A. A similar reaction is performed by refluxing an alcoholic Azure A and poly(acrylic acid) solution for 60 minutes and dialyzing to remove unreacted Azure A.

Since singlet oxygen is required to inactivate viruses in accordance with the invention, it is essential to maximize its production. The amount of singlet oxygen produced depends upon the absorptivity of the dye, the quantum yield of the dye (amount of singlet oxygen produced per photon absorbed), the overlap of the absorption spectrum of the dye and the emission spectrum of the light source, and the intensity of the light source. Other critical factors in choosing suitable dyes include their resistance to degradation via reaction with singlet oxygen, the ease with which the dye can be attached to the surface and its cost.

Fortunately, the emission spectra of solar, tungsten, and fluorescent light illuminants are well known In addition, the absorption spectra and quantum yield for singlet oxygen production have been determined for many commercially available dyes. The absorption spectra and singlet oxygen quantum yields are easily measured for other dyes using the test chamber and singlet oxygen analysis procedure, described later herein in this document. In addition, the available reactive sites on many fiber types are known and it is a simple matter to attach the dyes to the surface or to a binder molecule which can then be attached to the surface.

The following is a further example of a use of the invention.

Madin-Darby canine kidney (MDCK) epithelial cells are cultured in Dulbecco's modified Eagle's medium (DMEM) supplemented with 10% fetal calf serum, 100 U/ml penicillin, and 100 μg/ml streptomycin. MDCK cells are grown in 75 cm² polystyrene cell culture flasks at 37° C. and 5% CO₂. These cells support growth of a wide range of animal viruses including VSV, Vaccinia, adeno and reoviruses, and influenza viruses. Influenza A/WSN/33 virus (H1N1) are propagated in MDCK cells. A/WSN/33 is a common laboratory strain. It replicates in a variety of murine tissues and cultured cells. 2 cm² treated or control fabric sections is soaked in a virus suspension of ˜2×10⁸ plaque forming units per ml then transferred to 35 mm cell culture dishes. The dishes containing virus-soaked fabric sections are placed below the desired light source and illuminated for the indicated length of time. Light intensity is measured with a visible light meter. Following illumination, fabric sections are transferred to 15 ml conical polypropylene tubes containing 3 ml of serum-free DMEM. The tubes are vortexed for 10-15 seconds to release viruses from the fabric into the culture medium.

The virucidal activity is analyzed by serial dilution by factors of 10. The data is reported as

$$N = {log}_{10} \frac{Initial number of plaque forming units}{Number of plaque forming units after light exposure}$$

where N is the “log kill” ratio for this treatment. A log kill ratio of three indicates that 99.9% of the viruses are inactivated by that filter media with the specified exposure. Each measurement is performed ten times and both positive controls and negative controls are used to ensure that the test is valid. The log kill ratios are compared for each of these cases to determine whether adequate protection was obtained using this approach. Adequate protection is defined as a log kill ratio of 2 (99% inactivation) after 30 minutes exposure.

Specific filter applications are contemplated as possible for use with influenza as a personal filter. In addition, following are other possible applications of the invention described herein.
1) Filters
   home HVAC systems
   office buildings
   hospitals; and
   aircraft cabin filters.
2) Masks:
   military
   homeland defense
   NIH “pandemic”
   international; and
   retail
3) Furniture and furnishings:
   hospital waiting rooms
   hospital operating theatres
   wallpaper
   chairs
   day care centers;
   military uniforms; and
   aircraft cabin upholstery and wall coverings.

Having thus described the invention in detail, it will be better understood from the appended claims in which it is set form in a non-limiting manner.

What is claimed is:

1. A method of inhibiting growth of viruses, comprising:
attaching an effective amount of a dye, selected from one of reactive dyes and dyes containing reactive functional groups, onto a substrate, said composition of said dye being further characterized by having the ability to absorb light in a predetermined spectrum and intensity range to thereby produce singlet oxygen in the presence of an oxygen containing atmosphere, upon absorption of light in said predetermined spectrum range, in an amount effective to inactivate viruses when in contact therewith: and
contacting viruses to be inactivated with said substrate having said composition adhered thereto in the presence of oxygen and light in said predetermined spectrum and intensity range.

2. The method of claim 1, wherein said dye comprises at least two different dyes, each having a spectrum of light absorption different from the others to generate singlet oxygen.

3. The method of claim 1, wherein said dye comprises at least three different dyes, each having a spectrum of light absorption different from the others to generate singlet oxygen.

4. The method of claim 1, wherein said dye contains a reactive functional group comprised of at least one amino-, carboxylic-, hydroxyl-, alkene- and thiol.

5. The method of claim 1, wherein said dye is directly grafted onto a substrate comprised of cellulosic fibers.

6. The method of claim 1, wherein said dye is attached to a mediator polymer which is attached to the substrate.

7. The method of claim 1, wherein said dye is selected from at least one of xanthenes, phenothiazines, fluoresceines, acridine dyes, porphyrins, phthalocyanines, anthracene derivatives, anthraquinones and combinations thereof.

8. The method of claim 1, wherein said dye is at least one of Rose Bengal, thionin, Azure A, Acridine Yellow G, protoporphyrin IX, A1 protoporphyrin IX and Zn protoporphyrin IX.

9. The method of claim 1, wherein said substrate is at least one fiber.

10. The method of claim 1, wherein said substrate is a fabric.

11. The method of claim 1, wherein said substrate is a surface.

12. The method of claim 11, wherein said surface is an air filtration material.

13. The method of claim 1, wherein said dye has the following basic structure: 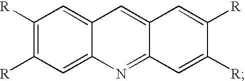
where R is a hydrogen, a hydroxyl, a carboxylic acid, an alkyl, an amino or a substituted amino group or other group; at least one of the R's being an amino, hydroxyl, carboxylic acid, or other reactive group.

14. The method of claim 13, wherein said dye is at least one of proflavin, acroflavin and acridine yellow G.

15. The method of claim 13, wherein said dye is acridine yellow G.

16. An article of manufacture capable of inhibiting growth of viruses comprising:
a substrate; and
an effective amount of a composition of a dye selected from at least one of reactive dyes and dyes containing reactive functional groups, attached to said substrate, said dye being further characterized by having the ability to absorb light in a predetermined spectrum and intensity range and to produce singlet oxygen in the presence of an oxygen containing atmosphere, upon absorption of light of said predetermined spectrum and intensity range, in an amount effective to inactivate viruses when in proximity thereto.

17. The article of claim 16, wherein said dye comprises at least two different dyes, each having a spectrum of light absorption different from the others to generate singlet oxygen.

18. The article of claim 16, wherein said dye comprises at least three different dyes, each having a spectrum of light absorption different from the others to generate singlet oxygen.

19. The article of claim 16, wherein said dye contains a reactive functional group comprised of at least one amino-, carboxylic- hydroxyl-, alkene- and thiol.

20. The article of claim 16, wherein said dye is directly grafted onto a substrate comprised of cellulosic fibers.

21. The article of claim 16, wherein said dye is attached to a mediator polymer which is attached to the substrate.

22. The article of claim 16, wherein said dye is selected from at least one of xanthenes, phenothiazines, fluoresceines, acridine dyes, porphyrins, phthalocyanines, anthracene derivatives, anthraquinones and combinations thereof.

23. The article of claim 16, wherein said substrate is at least one fiber.

24. The article of claim 16, wherein said substrate is a fabric.

25. The article of claim 16, wherein said substrate is a surface.

26. The article of claim 25, wherein said surface is an air filtration material.

27. The article of claim 16, wherein said dye is at least one of Rose Bengal, thionin, Azure A, Acridine Yellow G, protoporphyrin IX, A1 protoporphyrin IX and Zn protoporphyrin IX.

28. The article of claim 16, wherein said dye has the following basic structure: 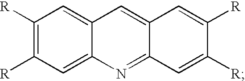
where R is a hydrogen, a hydroxyl, a carboxylic acid, an alkyl, an amino or a substituted amino group or other group; at least one of the R's being an amino, hydroxyl, carboxylic acid, or other reactive group.

29. The article of claim 28, wherein said dye is at least one of proflavin, acroflavin and acridine yellow G.

30. The article of claim 28, wherein said dye is acridine yellow G.

31. A method of manufacturing an article capable of inhibiting growth of viruses, comprising providing a substrate:
attaching an effective amount of a composition of a dye to said substrate, said dye selected from at least one of a reactive dye and dyes containing reactive functional groups, said dye being further characterized by having the ability to absorb light in a predetermined spectrum and intensity range to produce singlet oxygen in the presence of an oxygen containing atmosphere, upon absorption of light of said predetermined spectrum and intensity range, in an amount effective to inactivate viruses when in proximity thereto.

32. The method of manufacturing of claim 31, wherein said dye comprises at least two different dyes, each having a spectrum of light absorption different from the others to generate singlet oxygen.

33. The method of manufacturing of claim 31, wherein said dye comprises at least three different dyes, each having a spectrum of light absorption different from the othersto generate singlet oxygen.

34. The method of manufacturing of claim 31, wherein said dye contains a reactive functional group comprised of at least one amino-, carboxylic-, hydroxyl-, alkene and thiol.

35. The method of manufacturing of claim 31, wherein said dye is directly grafted onto a substrate comprised of cellulosic fibers.

36. The method of manufacturing of claim 31, wherein said dye is attached to a mediator polymer which is attached to the substrate.

37. The method of manufacturing of claim 31, wherein said dye is selected from at least one of xanthenes, phenothiazines, fluoresceines, acridine dyes, porphyrins, phthalocyanines, anthracene derivatives, anthraquinones and combinations thereof.

38. The method of claim 31, wherein said substrate is at least one fiber.

39. The method of claim 31, wherein said substrate is a fabric.

40. The method of claim 31, wherein said substrate is a surface.

41. The method of claim 40, wherein said surface is an air filtration material.

42. The method of manufacturing of claim 31, wherein said dye is at least one of Rose Bengal, thionin, Azure A, Acridine Yellow G, protoporphyrin IX, A1 protoporphyrin IX and Zn protoporphyrin IX.

43. The method of manufacturing of claim 29, wherein said dye has the following basic structure: 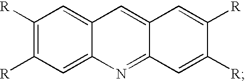
where R is a hydrogen, a hydroxyl, a carboxylic acid, an alkyl, an amino or a substituted amino group or other group; at least one of the R's being an amino, hydroxyl, carboxylic acid, or other reactive group.

44. The method of manufacturing of claim 43, wherein said dye is at least one of proflavin, acroflavin and acridine yellow G.

45. The method of manufacturing of claim 43, wherein said dye is acridine yellow G.
